(19) United States
(12) Patent Application Publication
(10) Pub. No.: US 2015/0325850 A1
(43) Pub. Date: Nov. 12, 2015

(54) SECONDARY BATTERY COMPRISING SULFUR PARTICLE HAVING CORE-SHELL STRUCTURE

(71) Applicant: Hyundai Motor Comapny, Seoul (KR)

(72) Inventors: Yong Jun Jang, Seongnam (KR); Ho Taek Lee, Seoul (KR); Sang Jin Park, Bucheon (KR)

(21) Appl. No.: 14/535,592

(22) Filed: Nov. 7, 2014

(30) Foreign Application Priority Data
May 8, 2014 (KR) 10-2014-0055066

(51) Int. Cl. H01M 4/36; H01M 4/1393; H01M 4/62; H01M 4/04; H01M 4/38

(52) U.S. Cl. CPC H01M 4/366; H01M 4/0402; H01M 4/38; H01M 4/625; H01M 4/1393

(57) ABSTRACT

Disclosed is a method of preparing a sulfur particle having a core-shell structure for a secondary battery. In particular, the method includes using Inverse Miniemulsion reaction and coating a carbon-based conducting material on the outer wall of the sulfur particle, to form a micronet from the carbon-based conducting material. Accordingly, self-discharge effect of the secondary batter may be reduced and life time may be improved by inhibiting loss of polysulfide during charge/discharge.

### CROSS-REFERENCE TO RELATED APPLICATION

This application claims under 35 U.S.C. §119(a) the benefit of Korean Patent Application No. 10-2014-0055066 filed on May 8, 2014, the entire contents of which are incorporated herein by reference.

### TECHNICAL FIELD

The present invention relates to a porous conducting sulfur nanocomposite having a core-shell structure for preventing polysulfide shuttle phenomenon inside of a lithium-sulfur secondary battery.

### BACKGROUND

Secondary batteries have been used as high-capacity power storage batteries for electric vehicles, battery power storage systems and the like, and as compact and high performance energy sources for portable electronic devices such as cellular phone, camcorder, notebook computer and the like. With the aims of decreased size and extended continuous use of the portable electronic devices, research has been conducted to reduce weight of the parts and power consumption of the secondary batteries. In addition to such efforts, the secondary batteries may be required to be compact in size and have substantially high capacity.

As a secondary battery, a lithium ion battery may have greater energy density and capacity per area than a nickel-manganese battery or a nickel-cadmium battery. Further, the lithium ion battery may have reduced self-discharge rate and improved life time. In addition, the lithium ion battery may be used more easily and for a greater period of time because it does not have memory effect. However, for a battery used for the next generation electric vehicle, the lithium ion battery may have various defects such as reduced stability caused by overheating, low energy density, low output and the like. Accordingly, post lithium ion batteries such as a lithium-sulfur secondary battery and a lithium-air secondary battery, which may provide improved output and improved energy density, have been actively developed to overcome such defects of the conventional lithium ion battery.

For example, the lithium-sulfur secondary battery has shown improved energy density of about 2500 Wh/kg, which is about 5 times greater than theoretical energy density of the conventional lithium ion battery. Accordingly, the lithium-sulfur secondary battery may provide a suitable option for electric vehicles which require a battery of substantially high output and substantially high energy density. However, self-discharge effect may occur in the lithium-sulfur secondary battery due to polysulfide shuttle phenomenon, which may further cause life time reduction of the lithium-sulfur battery.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides technical solutions to the above-described problems in the related art.

In one aspect, the present invention provides a sulfur particle nanocomposite used for of a lithium-sulfur secondary battery. The sulfur particle nanocomposite may be manufactured by preparing a sulfur particle using Inverse Miniemulsion reaction; and coating a carbon-based conducting material on the outer wall of the sulfur particle, thereby forming micronet of the carbon-based conducting material. Accordingly, self-discharge effect of the lithium-sulfur secondary battery may be reduced and life time of the battery may be improved by inhibiting loss of polysulfide during charge/discharge.

In an exemplary embodiment, the present invention provides a method for manufacturing a sulfur nanocomposite of a lithium-sulfur secondary battery, which may comprise: dispersing a sulfur in a hydrophilic ether solvent; adding and redispersing an amphiphilic copolymer in the hydrophilic ether solvent to contain the sulfur in a micelle structure of the amphiphilic copolymer; further adding a carbon material, which is dispersed in a same hydrophilic ether solvent used for dispersing the sulfur, to the micelle structure of the amphiphilic copolymer, to coat the carbon material on the outer wall of the micelle structure; and freeze drying the coated micelle structure. As a consequence, the sulfur nanocomposite may be formed to have a core-shell structure formed of inner sulfur particles and the carbon material.

In exemplary embodiments, the hydrophilic ether solvent may be at least one selected from a group consisting of dioxane, tetrahydrofuran, dimethoxyethane, polyethylene glycol, polypropylene glycol and polytetramethylene ether glycol. In addition, the amphiphilic copolymer may be at least one selected from a group consisting of polyethyleneoxidepolypropyleneoxide, polyethyleneoxidepolypropyleneoxidepolyethyleneoxide, polypropyleneoxidepolyethyleneoxidepolypropyleneoxide and polystyrenepolyethyleneoxide. Further, the carbon material may be porous. The carbon material may be selected from a group consisting of Single Walled Carbon Nanotube, Multi Walled Carbon Nanotube, Vapor Grown Carbon Fiber and Carbon Black. In The core-shell structure may have diameter of about 200 to 500 nm.

In another aspect, the present invention provides a method for manufacturing a cathode of a lithium-sulfur secondary battery, which includes the sulfur particle nanocomposite as described above. In particular, the method of manufacturing a cathode of a lithium-sulfur secondary battery may include: mixing the sulfur nanocomposite, a conducting material, a binder and MPN (N-Methylpyrrolidone) solvent to obtain slurry; and drying and crushing the slurry, and then coating the slurry on an electrode plate. The cathode may have composition of a sulfur in an amount of about 40 to 85 wt %, an amphiphilic copolymer in an amount of about 1 to 5 wt %, a conducting material in an amount of about 10 to 50 wt % and a binder in an amount of about 2 to 25 wt % based on the total weight of the cathode.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 schematically shows an exemplary method of manufacturing the sulfur nanocomposite having core-shell structure according to an exemplary embodiment of the present invention; and

FIG. 2 shows an exemplary charge/discharge graph of exemplary secondary batteries from Example (sample 2) which uses an exemplary sulfur nanocomposite having core-shell structure according to an exemplary embodiment of the present invention as a cathode material, and Comparative Example (sample 1) which uses a cathode material manufactured by the conventional ball mill method.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

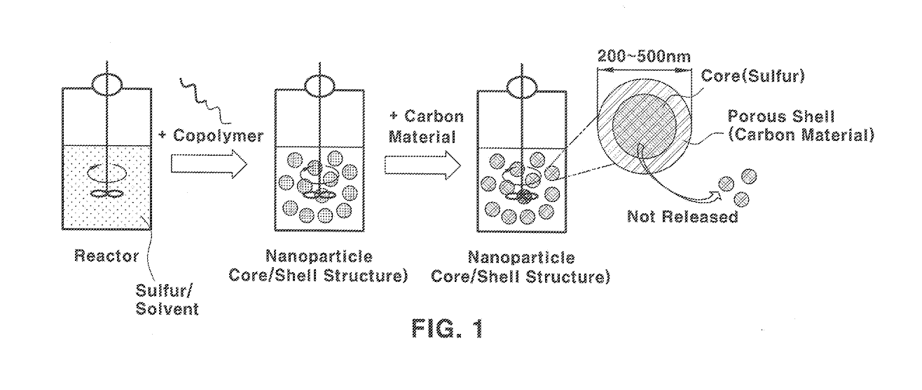

FIG. 1 illustrates an exemplary process of manufacturing a porous conducting material-sulfur nanocomposite having core-shell structure using the method in an exemplary embodiment of the present invention.

As shown in FIG. 1, sulfur may be dispersed in a hydrophilic ether solvent, and then an amphiphilic copolymer may be added to the hydrophilic ether solvent. The amphiphilic copolymer may be, but not limited to, polyethyleneoxidepolypropyleneoxide, polyethyleneoxidepolypropyleneoxidepolyethyleneoxide, polypropyleneoxidepolyethyleneoxidepolypropyleneoxide or polystyrenepolyethyleneoxide and the like. Accordingly, a micelle of nanoparticle may be formed and the amphiphilic copolymer may contain sulfur in the core of the micelle. When the micelle is stabilized, a carbon material dispersed in the same hydrophilic ether solvent used for dispersing the sulfur may be added to the micelle formed of the sulfur and the amphiphilic copolymers, and the carbon material may be coated on the surface of the micelle. Subsequently, the resulting material may be freeze-dried by freeze drying process to more stably obtain the nanocomposite particle.

In an exemplary embodiment, the present invention provides a method of manufacturing a sulfur nanocomposite of a lithium-sulfur secondary battery. The method may include: dispersing a sulfur in a hydrophilic ether solvent; adding and redispersing an amphiphilic copolymer in the hydrophilic ether solvent to contain the sulfur in a micelle structure of the amphiphilic copolymer; further adding a carbon material, dispersed in the same hydrophilic ether solvent used for dispersing the sulfur, to the micelle structure of the amphiphilic copolymer, to coat the carbon material on the outer surface of the micelle structure; and freeze drying the coated micelle structure.

In particular, the obtained sulfur nanocomposite may have a core-shell structure formed of the sulfur particle and the carbon material. The hydrophilic ether solvent may be at least one selected from a group consisting of dioxane, tetrahydrofuran, dimethoxyethane, polyethylene glycol, polypropylene glycol and polytetramethylene ether glycol.

The amphiphilic copolymer may be at least one selected from a group consisting of polyethyleneoxidepolypropyleneoxide, polyethyleneoxidepolypropyleneoxidepolyethyleneoxide, polypropyleneoxidepolyethyleneoxidepolypropyleneoxide and polystyrenepolyethyleneoxide, or in particular, the amphiphilic copolymer may be polyethyleneoxidepolypropyleneoxide. The carbon material may be a porous material, and in particular, may be selected from a group consisting of Single Walled Carbon Nanotube, Multi Walled Carbon Nanotube, Vapor Grown Carbon Fiber and Carbon Black.

Additionally, the core-shell structure may have diameter of about 200 to 500 nm. When the particle diameter is less than about 200 nm, the carbon may not be coated sufficiently, and when the particle diameter is greater than about 500 nm, polysulfide shuttle may not be prevented.

Furthermore, the present invention provides a method of manufacturing a cathode of a lithium-sulfur secondary battery. The method may include: mixing the sulfur nanocomposite manufactured by the method described above, a conducting material, a binder and MPN solvent to obtain slurry; and drying and crushing the slurry, and then coating the slurry on an electrode plate.

In particular, the cathode may have composition of the sulfur in an amount of about 40 to 85 wt %, the amphiphilic copolymer in an amount of about 1 to 5 wt %, the conducting material in an amount of about 10 to 50 wt % and the binder in an amount of about 2 to 25 wt %. The cathode having such composition may be more useful than another cathode having the same composition but using another type of sulfur such as pure sulfur. In various exemplary embodiments, the carbon material having porous structure of about several nanometers may hold the sulfur ingredient and block release of polysulfide when a secondary battery is discharged. Accordingly, the previously reported problems in the related art such as reduction of an active material may be eliminated and life time may be improved.

Further, the sulfur nanoparticle may have greater availability as an active material than the various conventional microparticles and may be produced in a larger scale by solution process compared to ball mill process. Accordingly, the present invention may provide various advantages compared to the conventional sulfur particle structure. For example, 1) a three dimensional network structure may be formed having pores which may cage (e.g., enclose or contain) the lithium polysulfide and prevent diffusion of the lithium polysulfide; and 2) polysulfide shuttle phenomenon may be prevented since the lithium polysulfide may not be diffused into an electrolyte, and thus self-discharge effect during charge may also be prevented, thereby improving life time of a battery.

### Examples

The following examples illustrate the invention and are not intended to limit the same.

### Example (Sample 2)

1) Sulfur was added to toluene and dispersed using an ultrasonicator.

2) Polyethyleneoxidepolypropyleneoxide as a copolymer was added thereto and redispersed using an ultrasonicator.

3) When sulfur-copolymer micelle is stabilized, a carbon material dispersed in the same solvent was added to the sulfur and the polyethyleneoxidepolypropyleneoxide in the toluene, and then redispersed using an ultrasonicator.

4) The resulting material was dry freezed using liquid nitrogen, to obtain a nanocomposite having core/shell structure.

5) A slurry was prepared by mixing the prepared nanocomposite having core/shell structure, a conducting material, a binder and NMP (N-Methylpyrrolidone) as solvent. Ball milling, a mortar, a planetary mixer, a homomixer and the like may be used for mixing.

6) The mixed slurry was dried, crushed and used to manufacture a cathode composite.

7) The prepared slurry was coated on an electrode plate.

### Comparative Example (Sample 1)

Pure sulfur was mixed with a conducting material, a binder and MPN solvent using ball mill and the like, and the mixed slurry was coated on an electrode plate as described in steps of 5) to 7) of the Example without performing steps of 1) to 4).

Composition of the manufactured cathode is as shown in the following Table 1.

TABLE 1

| | Sulfur | | | |
|---|---|---|---|---|
| | | Sulfur nanocomposite | Conducting | |
| | Pure | having | material | Binder |
| Sample # | sulfur | core-shell structure | VGCF | PVdF |
| 1: | 71 wt % | | 23 wt % | 6 wt % |
| Comparative | | | | |
| Example | | | | |
| 2: Example | | 71 wt % | 23 wt % | 6 wt % |

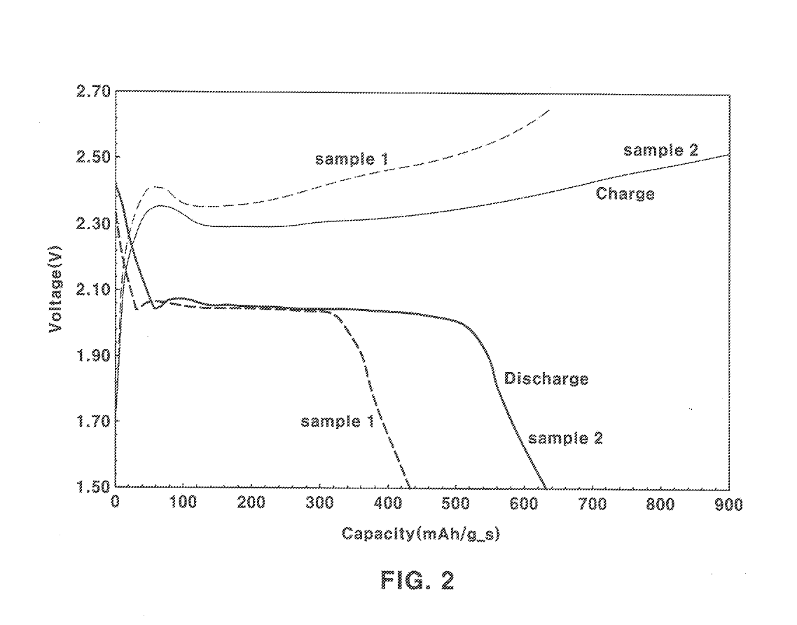

Discharge curves of the Example and the Comparative Example are as shown in FIG. 2.

The Comparative Example is a sulfur cathode manufactured by the conventional ball mill, and the Example is a sulfur cathode manufactured using the sulfur nanocomposite according to an exemplary embodiment of the present invention. As shown in the charge/discharge curve of FIG. 2, the Example shows greater energy capacity compared to the cathode of sample 1 (the Comparative Example) due to substantially improved sulfur cathode utilization.

Accordingly, the present invention may provide the following advantages, compared to the conventional structure: 1) a three dimensional network structure may be formed having pores, which may cage lithium polysulfide and prevent diffusion of the lithium polysulfide; and 2) polysulfide shuttle phenomenon may be prevented since the lithium polysulfide may not be diffused into an electrolyte, and self-discharge effect during charge may be prevented, thereby prolonging life time of a battery.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1. A method of manufacturing a sulfur nanocomposite of a lithium-sulfur secondary battery, comprising:
dispersing a sulfur in a hydrophilic ether solvent;
adding and redispersing an amphiphilic copolymer to the dispersed sulfur in the hydrophilic ether solvent to contain the sulfur in a micelle structure of the amphiphilic copolymer; and
further adding a carbon material, dispersed in a same hydrophilic ether solvent used for dispersing the sulfur, to the micelle structure of the amphiphilic copolymer, to coat the carbon material on the outer wall of the micelle structure; and
freeze-drying the coated micelle structure,
wherein the sulfur nanocomposite has a core-shell structure formed of the sulfur and the carbon material.

2. The method of claim 1, wherein the hydrophilic ether solvent is at least one selected from the group consisting of: dioxane, tetrahydrofuran, dimethoxyethane, polyethylene glycol, polypropylene glycol, and polytetramethylene ether glycol.

3. The method of claim 1, wherein the amphiphilic copolymer is at least one selected from the group consisting of: polyethyleneoxidepolypropyleneoxide, polyethyleneoxidepolypropyleneoxidepolyethyleneoxide, polypropyleneoxidepolyethyleneoxidepolypropyleneoxide, and polystyrenepolyethyleneoxide.

4. The method of claim 1, wherein the carbon material is porous.

5. The method of claim 4, wherein the carbon material is selected from the group consisting of: Single Walled Carbon Nanotube, Multi Walled Carbon Nanotube, Vapor Grown Carbon Fiber, and Carbon Black.

6. The method of claim 1, wherein the core-shell structure has a diameter of about 200 to 500 nm.

7. A method of manufacturing a cathode of a lithium-sulfur secondary battery, comprising:
mixing a sulfur nanocomposite, a conducting material, a binder and a MPN (N-Methylpyrrolidone) solvent to obtain a slurry; and
drying and crushing the slurry, and then coating the slurry on an electrode plate,
wherein the sulfur nanocomposite is prepared by:
dispersing a sulfur in a hydrophilic ether solvent;
adding and redispersing an amphiphilic copolymer to the dispersed sulfur in the hydrophilic ether solvent, to contain the sulfur in a micelle structure of the amphiphilic copolymer;
further adding a carbon material, dispersed in a same hydrophilic ether solvent used for dispersing the sulfur, to the micelle of the amphiphilic copolymer, to coat the carbon material on the outer wall of the micelle structure; and
freeze-drying the coated micelle structure,
wherein the sulfur nanocomposite has a core-shell structure formed of the sulfur and the carbon material.

8. The method of claim 7, wherein the cathode has composition of the sulfur in an amount of about 40 to 85 wt %, the amphiphilic copolymer in an amount of about 1 to 5 wt %, the conducting material in an amount of about 10 to 50 wt % and the binder in an amount of about 2 to 25 wt %
